(19) United States
(12) Patent Application Publication
(10) Pub. No.: US 2013/0245958 A1
(43) Pub. Date: Sep. 19, 2013

(54) ACCURATE COMPARISON AND VALIDATION OF SINGLE NUCLEOTIDE VARIANTS

(71) Applicants: Michael FORSTER, Kiel (DE); Andre FRANKE, Kronshagen (DE); Andreas KELLER, Puettlingen (DE)

(72) Inventors: Michael FORSTER, Kiel (DE); Andre FRANKE, Kronshagen (DE); Andreas KELLER, Puettlingen (DE)

(73) Assignee: Siemens Aktiengesellschaft, Munich (DE)

(21) Appl. No.: 13/795,492

(22) Filed: Mar. 12, 2013

Related U.S. Application Data
(60) Provisional application No. 61/611,074, filed on Mar. 15, 2012.

(51) Int. Cl. G06F 19/22

(52) U.S. Cl. CPC G06F 19/22
USPC 702/19

(57) ABSTRACT

A method is disclosed for validation of single nucleotide variants (SNV) in a sequence of interest. In at least one embodiment, the method includes: interrogating a BAM-file of the sequence of interest and a reference sequence file and producing a summary table for genomic coordinates of interest; generating a plurality of sequence reads from a sample of said sequence of interest; filtering sequence reads using a plurality of filter levels; extracting SNV counts for each strand for a genomic region of interest within the sequence of interest, resulting in ten SNV counts; for each genomic region of interest determining a rule based genotype decision and inferring a best genotype from the 10 counts; and creating a single consensus file for said sequence of interest including information of best genotype and a best quality for each genomic region of interest.

### PRIORITY STATEMENT

The present application hereby claims priority under 35 U.S.C. §119(e) to U.S. Provisional patent application No. 61/611,074 filed Mar. 15, 2012, the entire contents of which are hereby incorporated herein by reference.

### FIELD OF INVENTION

The invention generally relates to methods for accurately comparing and validating of single nucleotide variants.

### BACKGROUND

The first step in next-generation sequencing (NGS) of genomic DNA is the massively parallel sequencing of millions to billions of short DNA fragments on a single platform, typically generating short FASTA sequences (termed “reads”) from each end of the DNA fragment. For quality control purposes, the NGS platforms also generate PHRED-like quality values (1) for every FASTA base. The second step, which involves a high performance workstation or a compute cluster, is to determine the most probable genomic origin of each fragment by aligning the reads to a reference, typically to the sequences of a whole genome. Automatic, fast, and error-tolerant alignment methods such as BWA exist (2), enabling the huge numbers of reads to be aligned within a reasonable time span. The third step, also carried out on a workstation or a computer cluster, is the identification (“calling”) of variants from the resulting consensus alignments. This variant-calling is not straightforward, because of existing experimental and platform differences, alignment ambiguities, and biological particularities such as ploidy changes in tumors. Typically, single nucleotide variant (SNV)-calling algorithms generate SNV-lists using filtering or probabilistic methods to exclude artifacts.

Quality control (QC) of NGS SNV data is vital and by definition needs to be performed independently of the data production. For example, the SNVs released by the 1000 Genomes Project (3) were a consensus from at least two different groups, two different NGS platforms, and two different bioinformatic pipelines, significantly reducing the risk of human errors, platform errors, and software errors, respectively. Data exchange errors within the 1000 Genomes Project were mitigated by developing shared conventions, including the current standard alignment file format BAM (4) and the variant file format VCF (5).

A BAM file (.bam) is the binary version of a SAM file. A SAM file (.sam) is a tab-delimited text file that contains sequence alignment data. These formats are described on the SAM Tools web site: http://samtools.sourceforge.net.

VCF is a text file format (most likely stored in a compressed manner). It contains meta-information lines, a header line, and then data lines each containing information about a position in the genome.

### SUMMARY

The inventors note that the accurate calling of SNPs from massive parallel sequencing data remains a challenge. The inventors developed a tool for computing SNPs with extremely high specificity and sensitivity.

So far the problem has not been solved by computational devices/programs, Sanger Sequencing as validation experiments was necessary.

In at least one embodiment, the inventors developed a new method (herein also referred to as “pibase”) that is applicable to diploid genome, exome, or targeted enrichment data. pibase extracts various details on nucleotides from alignment files (BAM files) at arbitrary coordinates (e.g. from VCF files) and identifies “stable” genotypes (99.99% specificity in our example). It also provides pair-wise comparisons using Fisher's exact test on nucleotide signals (ten-fold more accurate than a genotype-based approach, as shown in our case study of monozygotic twins). These comparisons are sensitive even to allelic imbalance at heterozygous SNVs located, e.g. in copy number variations, or that are present in heterogeneous tumor sequences. Additionally, pibase generates data for phylogenetic network analyses (evolutionary and sample confusion analyses) and outputs human-readable tables and VCF files.

By such a method more reliable diagnosis can be carried out in much shorter time. Respective approaches are essential to enable next-generation sequencing in the clinical routine and may ease the FDA approval process.

Historically, existing QC tools include FASTQC (http://www.bioinformatics.bbsrc.ac.uk/projects/fastqc/), for checking sequence output before mapping, and the Variant Quality Score Recalibration tool (VQSR) (6) which statistically grades false positive SNV-calls using “true data” (6) and a set of SNV-calls. VQSR performs best for large SNV sets of at least human exome size (6). Manual inspection of the aligned reads using a viewer such as IGV (7) often helps to identify false negative and false positive calls but is infeasible for large numbers of loci or samples (requiring about three or more minutes per genomic coordinate for careful inspection and documentation). QC is starting to be achieved within a process control context, and process control using standard operating procedures (SOPs). In the wet lab, the SOPs may consist of the vendor protocols, and in bioinformatics the SOPs may consist of using open bioinformatic frameworks such as Galaxy (8, 9) or GATK (10). For the record, the Galaxy framework includes optional FASTQ filters (11) and FASTQC for raw sequence QC before mapping. Galaxy also includes Picard (http://picard.sourceforge.net/) for optional post-mapping filtering of duplicate reads in BAM files. For optional post-SNV-calling QC, Galaxy provides an interface to IGV, and for optional genotype-based Mendelian error checks Galaxy provides an interface to PLINK (12). Currently Galaxy provides no interface to VQSR. The GATK framework is a collection of Linux command-line based tools that includes VQSR for post-SNV-calling QC. Both Galaxy and GATK allow the inclusion of further linux command line tools. Some groups prefer to use a single SNV-caller, while our group for example employs two different SNV-callers per NGS platform which helps us to identify significantly more potential SNVs.

By employing several different SNV-callers, e.g. SOLiD Bioscope, SAMtools (4), GATK, and VarScan (13), users can perform a basic validation of the SNV-lists by intersecting the individual SNV-lists to separate cross-validated SNVs from less validated ones. However, this approach replaces valid SNVs with reference sequence genotypes, therefore introducing genotyping errors on the one hand, and leading to false differences when two or more samples are compared, on the other hand. This is part of a broader problem. SNV-lists include incorrectly identified genotypes where a single quality filtering setting of machine output or read-alignment was insufficient, and SNV-lists fail to include genotypes where a single quality filtering setting was too stringent (6) or where sequencing failed in the first place. Available variant-calling software usually implicitly identifies unconfident genotypes or sequencing failures as a reference sequence genotype (reference sequence bias), which can sum up to a 59.7% error rate (Supplementary Table 1d). Part of the underlying problem is that the approaches outlined above are based on successively filtered data in different software, rather than on the full data available in BAM files, and that some valid SNVs are usually suppressed by this filtering. Another problem is that probabilistic approaches sometimes inexplicably mis-identify very obvious genotypes. As a specific problem in cell comparisons, it is sometimes necessary to detect significant allelic balance changes in heterozygous SNVs, e.g. in heterogeneous tumor samples or in the case of copy number variation loci.

Before embodiments of the invention are described in detail, it is to be understood that this invention is not limited to the particular component parts of the process steps of the methods described as such methods may vary. It is also to be understood that the terminology used herein is for purposes of describing particular embodiments only, and is not intended to be limiting. It must be noted that, as used in the specification and the appended claims, the singular forms “a,” “an” and “the” include singular and/or plural referents unless the context clearly dictates otherwise. It is also to be understood that plural forms include singular and/or plural referents unless the context clearly dictates otherwise. It is moreover to be understood that, in case parameter ranges are given which are delimited by numeric values, the ranges are deemed to include these limitation values.

Embodiments of the invention relate to methods of genetic analysis as described herein.

In one aspect, at least one embodiment of the invention relates to a method for validation of single nucleotide variants(SNV) in a sequence of interest, comprising:
interrogating a BAM-file of said sequence of interest and a reference sequence file of said sequence of interest and producing a summary table for genomic regions or genomic coordinates of interest,
generating a plurality of sequence reads from a sample of said sequence of interest,
filtering sequence reads using a plurality of filter levels,
extracting SNV counts for A, C, G, T, N for each strand for a genomic region of interest within said sequence of interest, resulting in ten SNV counts,
for each genomic region of interest determining a rule based genotype decision and inferring a best genotype from said 10 allele counts, and
creating a single consensus file for said sequence of interest comprising information of best genotype and a best quality for each genomic region of interest.

### BRIEF DESCRIPTION OF THE DRAWINGS

The invention is explained in more detail below with reference to an example embodiment taken in conjunction with the accompanying figures, in which:

FIG. 1 is a flow chart showing the standard NGS sequencing and bioinformatic analysis (top two boxes) followed by the “essential workflow” of pibase: pibase_bamref reads a list of genomic coordinates from a tab-separated text file, a VCF file, a SAMtools pileup SNV file, or a Bioscope gff3 SNV file. It then extracts data from a reference sequence file and a sequence alignment (BAM) file, and outputs extracted, computed, and filtered information as a tab-separated text file (output 1). pibase_consensus reads a single or several pibase_bamref files. For each coordinate, a “best genotype” with quality and strand support, as well as two genotypes for each filter level are inferred, and these data are appended to the pibase_bamref data (output 2). pibase_fisherdiff is a tool for association testing or sample comparison, requiring a pair of pibase_consensus files as input data (e.g. case/control, germline/tumor, or affected/unaffected twin). The tool appends p-values and a filter label to the pibase_consensus data (output 3). Further workflows address annotation and phylogenetic analysis; and

FIG. 2 is a median joining network showing the differences between the five example BAM files of the CEU trio which was downloaded from ftp.1000genomes.ebi.ac.uk/vol1/ftp/data/. The daughter (NA12878) was sequenced on Illumina, SOLiD and FLX, the father (NA12891) and the mother (NA12892) on Illumina only. The links between the nodes show the IDs of the discriminating SNVs.

It should be noted that these Figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

In one aspect, at least one embodiment of the invention relates to a method for validation of single nucleotide variants(SNV) in a sequence of interest, comprising:
interrogating a BAM-file of said sequence of interest and a reference sequence file of said sequence of interest and producing a summary table for genomic regions or genomic coordinates of interest,
generating a plurality of sequence reads from a sample of said sequence of interest,
filtering sequence reads using a plurality of filter levels,
extracting SNV counts for A, C, G, T, N for each strand for a genomic region of interest within said sequence of interest, resulting in ten SNV counts,
for each genomic region of interest determining a rule based genotype decision and inferring a best genotype from said 10 allele counts, and
creating a single consensus file for said sequence of interest comprising information of best genotype and a best quality for each genomic region of interest.

According to a further aspect of at least one embodiment of the invention, five filter levels are used and wherein the first filter level removes reads with insertions and/or deletions, the second filter level comprises a base quality filter, the third level comprises a mapped length filter, the fourth level comprises a mismatches-per-read filter, and the fifth level comprises a mapping quality filter.

According to a further aspect of at least one embodiment of the invention, said rule based genotype decision comprises only calling an allele if a predetermined percentage of reads (or at least one read, whichever is higher) support this allele, and if a predetermined percentage of unique starting points (or at least one unique starting point, whichever is higher) support this genotype.

According to a further aspect of at least one embodiment of the invention, the predetermined percentage of reads is at least 2.2% and the predetermined percentage of starting points is at least 4%.

According to a further aspect of at least one embodiment of the invention, an allele is only called if there are at least a predetermined number of reads per allele and at least a predetermined number of unique starting points per allele.

According to a further aspect of at least one embodiment of the invention, the predetermined number of reads is at least 4 and the predetermined number of starting points is at least 8.

According to a further aspect of at least one embodiment of the invention, the method further comprises annotating low quality genotypes and classifying the degree of low quality into a plurality of categories of increasingly poor quality.

According to a further aspect of at least one embodiment of the invention, the method comprises the further step of comparative analysis of at least two BAM files of interest.

According to a further aspect of at least one embodiment of the invention, wherein said comparative analysis comprises the use of Fisher's exact test.

According to a further aspect of at least one embodiment of the invention, said comparative analysis comprises the use of Fisher's exact test for a plurality of filter levels.

According to a further aspect of at least one embodiment of the invention, PCR based targeted enrichment of said sequence of interest is used prior to sequencing.

According to a further aspect of at least one embodiment of the invention, the method further comprises the step of annotating the single consensus file with further information.

According to a further aspect of at least one embodiment of the invention, said further information comprises a dbSNP name or a gene name.

According to a further aspect of at least one embodiment of the invention, said method is used for facilitating mitochondrial quality control and/or population genetic analyses.

According to a further aspect of at least one embodiment of the invention, the method comprises flagging non-reference genotypes as potential mismatches.

According to a further aspect of at least one embodiment of the invention, the method comprises the detection of hypervariable genomic regions by means of the plurality of sequence read filtering, and of flagging the genotypes in these hypervariable regions.

According to a further aspect of at least one embodiment of the invention, the method comprises the detection of genomic segmental duplications by means of the plurality of sequence read filtering, and of flagging the genotypes in these regions as being in a homologous region.

At least one embodiment of the invention further provides a computer-program product which is loadable or loaded into a memory of a computer, comprising commands, the commands being readable by the computer to perform the method of the invention when the commands are executed on the computer.

Herein described are the methods of embodiments of the invention which, instead of relying on a single set of filtering parameters, applies ten sets of filtering parameters and then infers the best genotype or the best comparison. The methods of the invention complement the available general data analysis tools. The methods of the invention save considerable manual validation work, and, unlike the manual approach, can be integrated into a bioinformatic pipeline.

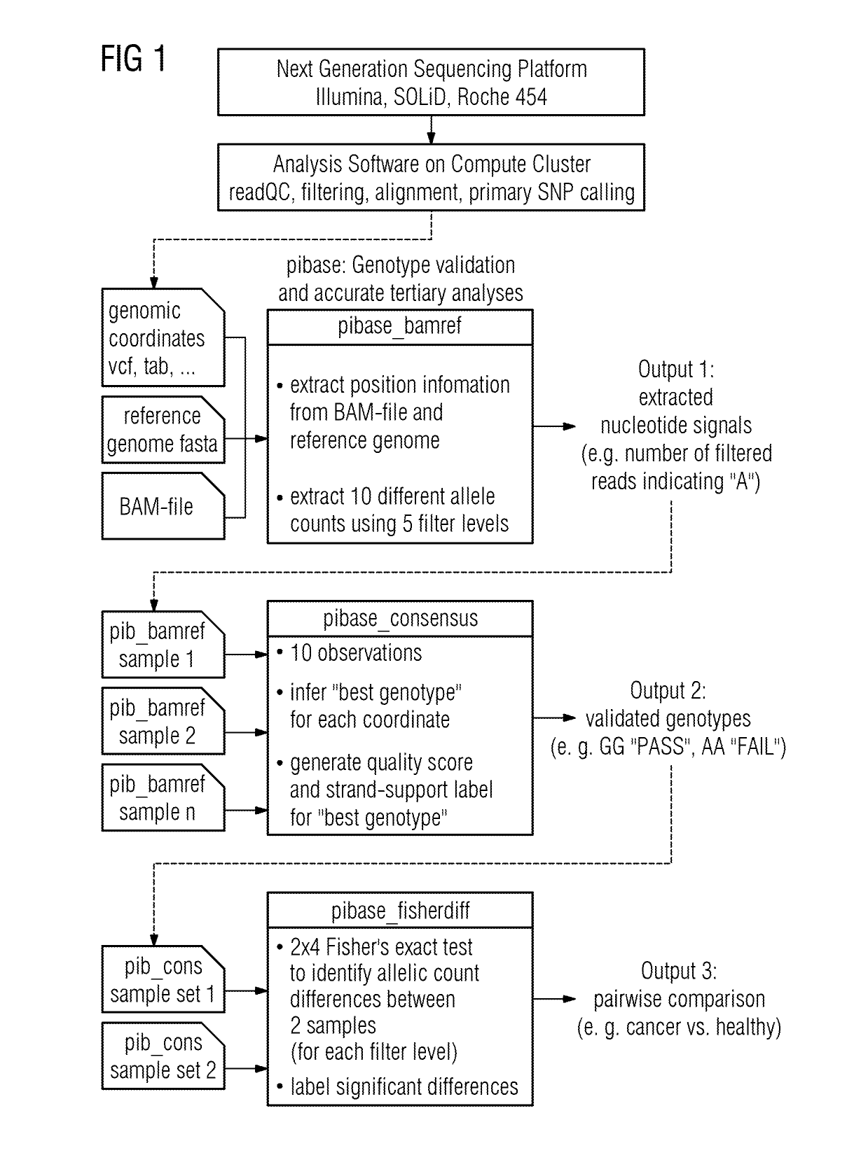

FIG. 1 depicts the essential workflow (the pre-requisite for all other workflows), in which pibase accepts BAM-files and extracts and tabulates nucleotide signals at genomic coordinates of interest using ten different observation methods or “filters” (from which pibase infers its “best genotype”): pibase observes reads and unique start points using five distinct and increasingly stringent quality filters (Table 1a). This information is therefore not restricted to a single stringency or a single filter setting, and is more complete and less biased than information from single-source SNV-lists or manual inspections. Additionally, reference sequence information is included in this table, which pibase requires and which, as a bonus, also reduces the need for manual inspections in a viewer. A genotype is inferred for each of the ten filter methods which all should ideally result in identical genotypes. A summary “best genotype” and its quality are computed from these ten observations (Table 1b). For directly comparing two data sets, e.g. patients vs. healthy controls in disease association studies, pibase uses a statistical approach on filtered read counts (original data) with associated quality control criteria rather than a simple comparison of SNV-lists (processed data). The inventors implemented this comparison because the inventors observed that SNV-calls or allele-calls may be suppressed in one of the samples being compared, merely because of stringency filters and coverage differences. Our approach should not be confused with the one implemented in CRISP (15), which dramatically improves the accuracy of rare variant calling in pools using Fisher's exact test on A- and B-allele counts and multiple pools of samples. Finally, pibase provides a link from genomic NGS data to median joining network analysis (16), which is widely used in the field of biology to generate evolutionary tree-like graphics for a population of individuals, in order to stratify the population and uncover evolutionary structures (“family trees”) and ancestral sequences.

Scientists working with single nucleotide variants (SNV), inferred by next-generation sequencing software, often need further information regarding true variants, artifacts, and sequence coverage gaps. Depending on the experimental setup, 2.1% to 59.7% of relevant SNVs might not be detected due to coverage gaps, or be misidentified. Even low error rates can overwhelm the true biological signal, especially in clinical diagnostics, in research comparing healthy with affected cells, in archaeogenetic dating, or in forensics. For these reasons the inventors have developed a package called pibase which is applicable to diploid and haploid genome, exome, or targeted enrichment data. pibase extracts details on nucleotides from alignment files (BAM) at user-specified coordinates (e.g. via VCF input files) and identifies reproducible (“stable”) genotypes, if present. In test cases pibase identifies genotypes at 99.98% specificity, ten-fold better than other tools. pibase also provides pair-wise comparisons between healthy and affected cells using nucleotide signals (ten-fold more accurately than a genotype-based approach, as the inventors show in our case study of monozygotic twins). This comparison tool also solves the problem of detecting allelic imbalance within heterozygous SNVs in copy number variation loci, or in heterogeneous tumor sequences. The pibase export formats include human-readable tables, VCF files, and phylogenetic network files.

The pibase package is structured into workflows and consists of linux command line tools which can be incorporated into sequential pipelines and into linux cluster pipelines. When developing pibase it was important to have simple commands and meaningful help texts at the command line. Equally important was exception trapping with meaningful error messages.

The essential workflow (FIG. 1) is complemented by optional workflows and some utilities. The “annotate workflow” adds annotations to outputs 2 or 3 (FIG. 1), using the command line version of our internal SNV categorisation package snpActs (http://snpacts.ikmb.uni-kiel.de). The “phylogenetics workflow” generates a data file which can be used by the median joining network analysis software (16) to compute evolutionary trees and ancestral sequences. Traditionally, median-joining networks are computed on the basis of mitochondrial markers or short tandem repeats (STR) on the Y-chromosome. These loci are usually sufficiently hyper-variable to discriminate between individuals of the same species. The mitochondrial and Y-STR loci are normally recombination-free, which is the pre-requisite for computing the maternal lineage and the paternal lineage, respectively. If an evolutionary network is to be constructed from a single individual's germ-line and somatic cells, any genomic marker is normally recombination-free within this cell population. Therefore, the inventors designed pibase to translate mitochondrial, Y-chromosomal, and diploid SNVs into a generic format for the network analysis software.

### “Essential Workflow” Tools

The pibase_bamref tool. The pibase_bamref tool interrogates the BAM-file and the reference sequence file and produces a summary table for the genomic coordinates of interest: This table contains the reference sequence context, which consists of the reference nucleotide with six upstream and six downstream nucleotides. The table also contains the allele coverage, which may include virtual (“optical”) duplicates and molecular duplicates (6), and unique read start points (14), which excludes duplicates but potentially also some desirable reads, for A, C, G, T, N on each strand and for five filter levels. The filter thresholds are user-controllable parameters. The first filter level removes reads with indels (insertions/deletions; usually alignment artifacts), the second level adds a base quality filter (e.g. default threshold: PHRED-like score of ≧20, (1)) removing many potential sequencing errors, the third level adds a mapped length filter (e.g. default threshold: ≧49 nucleotides) removing many potentially mismapped reads in lower-complexity regions of the genome, the fourth level adds a mismatches-per-read filter (default threshold is one mismatch) further removing many mismapped reads, and the fifth level adds a mapping quality filter (e.g. default threshold: MapQV ≧20), removing randomly mapped reads. These filters are familiar to bioinformaticians; however, our tool reports 10 different versions of nucleotide signal counts at the same time within an easy-to-process tab-separated text file, allowing algorithmic or manual comparison between the different filter-cases, in order to reliably infer the most plausible genotype. The genomic coordinates of interest can be specified on the command line, in a SAMtools pileup file, in a VCF file, or in a tab-separated text file.

It is known to the person skilled in the art that Phred quality scores are assigned to each base call in automated sequencer traces, they have become widely accepted to characterize the quality of DNA sequences, and can be used to compare the efficacy of different sequencing methods.

The pibase_consensus tool. The pibase_consensus tool computes further information which is appended to a pibase_bamref file, e.g. “best” genotypes and “best qualities”. Multiple pibase_bamref files (e.g. a panel of controls or several lanes or runs of the same patient) can be specified as input data, in which case read counts are merged into a single pibase_consensus file. For each genomic coordinate of interest the tool creates 10 rule-based genotype decisions and infers one “BestGen” (best genotype) and one “BestQual” (best quality) from these 10 genotypes, strand support for the A and B alleles of the “BestGen”, and summary allele counts for each of the 10 genotypes.

Genotypes can be called using the following rules: By default, an allele is called if at least 2.2% of reads (or at least one read, whichever is higher) support this allele, and if at least 4% of unique starting points (or at least one unique starting point, whichever is higher) support this allele. If there is more than one allele, and if the minor allele is supported by one read only, the minor allele is not called. If there is more than one allele, and if all alleles are supported by only one read each, the genotype is not called at all. The inventors set these thresholds for our high-sensitivity SOLiD and HiSeq experiments, because the inventors observed the sequencing errors to be ˜1% and were interested in detecting contaminants and mapping errors. The thresholds are user-controllable parameters. For other types of experiments or for older NGS platforms such as the Illumina GA II, users may prefer a threshold of 10% instead 2.2% and 4%.

Recently, the inventors estimated the SOLiD and HiSeq sequencing errors to be less than ˜1% by analyzing reads mapped in the mtDNA control region excluding evolutionary hotspots which are prone to heteroplasmy (17), for SOLiD v3 and v4 human whole genome experiments and human targeted enrichment experiments and for an Illumina HiSeq 2000 exome experiment. The inventors also analyzed genomic coordinates of known HapMap SNPs in the SOLiD v3 targeted enrichment experiment. The inventors quantified the noise of unexpected base-calls in the mapped reads at these SNV loci, which were not prone to mapping errors. The inventors classified this noise as sequencing errors. The noise in mtDNA was of similar magnitude as the noise in genomic DNA. The pibase_chrm_to_crs tool can be used to analyze noise in the mtDNA, provided that hg18, hg19 or NCBI human build 36 was used as the mapping reference.

BestGen and BestQual are computed according to the explanations in Table 3. Low quality genotypes are annotated with BestQual labels ?1 to ?8, where the degree of poor quality increases from ?1 to ?8. Positions with values above ?1 should be rejected or inspected further. If there is no label, the genotype is validated by all 10 filter methods at a minimal coverage of (by default) 8 reads per allele of which there are at least (by default) 4 unique starting points per allele. The quality grading aims to help the user understand the underlying mechanisms of each problem. These thresholds are user-controllable parameters.

Both-strandedness filters must be applied using the additional labels A+- and B+-, where a plus in the label denotes that the allele is supported by forward reads, and a minus denotes that the allele is supported by reverse reads. This feature accounts for enrichment methods that are strand-biased. Previously, the inventors observed occasional failure of both-stranded support to be common in next-generation sequencing. The inventors did not bundle the strandedness criterion into the BestQual label because it would otherwise become overloaded with information and filtering would be less intuitive. Poor quality genotypes and single-strand genotypes can then be filtered using the Linux commands grep and awk (as described in the pibase tutorial www.ikmb.uni-kiel.de/pibase/index.html#pibase_consensus), scripts, or Microsoft Excel.

The pibase_fisherdiff tool. pibase_fisherdiff is an optional tool which is required only for comparative analyses, i.e. pairwise comparisons and phylogenetic analyses. pibase_fisherdiff merges a case-control pair of pibase_consensus files, adding p-values and a label (for filtering). The pibase_consensus files can represent either a panel of cases (patients) and a panel of controls (healthy individuals) or a pair of single individuals, or a pair of DNA samples from the same individual. For each of the five (pibase_bamref) filter levels, the 2×4 Fisher's exact test (FET) two tailed p-value is computed (18) for the A, C, G, T unique start point counts. The median p-value of the 5 filter levels is computed, and based on this p-value, the filter label is generated which denotes identity or difference between case and control at the tested genomic coordinate. In addition to the p-value, the filter label computation is subject to two user-specified constraints: a coverage threshold and a factor threshold. The factor is defined as follows: If the major alleles are identical in both samples, the number of major allele counts divided by the number of minor allele counts must be less than the factor threshold. If the major alleles are different, the factor constraint is not applied. The coverage and factor constraints were introduced because the p-value alone can be insufficient in certain cases, for example when p-values are around 0.01, coverages are below 50 and just one read is shifted from the major allele to the minor allele or vice versa, i.e. when a normal sequencing error occurs. The maximal p-value (default threshold 0.01), minimal coverage at a genomic coordinate of interest (default threshold 100) and maximal factor (default threshold 100) are user-specifiable parameters.

The inventors implemented the 2×4 FET because it automatically compares tri-allelic or tetra-allelic genotypes, which can occur because of sequencing or mapping errors, contamination, copy number variations, and theoretically also genetic heterogeneity. For the special case of only one or two alleles, the inventors observed that the 2×4 FET yields the same p-values as the 2×2 FET. When the inventors introduced in silico contamination, the inventors observed that the 2×4 FET p-value converges towards the ideal 2×2 FET p-value. For coverage-based 2×4 FET the p-values were nearly identical to unique-start-point-based p-values. The inventors therefore implemented only unique-start-point-based 2×4 FET. The main advantage is that the maximal number of observations (i.e. read counts) can never be greater than 2 strands×max read length×4 alleles, even when panels are compared.

### “Annotate Workflow” Tools

The pibase_tag tool. The pibase_tag tool helps filtering when PCR based targeted enrichment was used prior to sequencing. The tool appends filtering labels to any pibase file, denoting whether a genomic coordinate is located within a PCR primer binding region and which strand is affected. The tool reads the primer binding region start, end, and strand from a tab-separated text file. SNV-calls in primer binding regions require more stringent filtering than normal, because the PCR cycles lead to primer sequence bias: Even if there is a mismatch in the primer binding region of the single stranded genomic DNA, a primer may bind to the DNA strand. This leads to the generation of a complementary strand by the polymerase chain reaction. In the next PCR cycle, a reverse primer binds to the complementary strand and generates a reverse complementary strand that includes the forward primer. For this reason, it is unlikely that a genome variant in a PCR primer region is detected, unless overlapping amplicons are used or both-stranded confirmation is sacrificed. In both cases, allelic balance is biased.

The annotation tools. pibase_tosnpacts and pibase_annot are used for annotating pibase-files with dbSNP names, gene names, and other information. Access to our annotation tool snpActs is required for these operations.

### “Phylogenetics Workflow” Tools

The pibase_chrm_to_crs tool. The pibase_chrm_to_crs tool facilitates mitochondrial quality control and population genetic analyses by scoring variants with respect to the Cambridge Reference Sequence (CRS) (19) from a pibase_consensus file generated from chrM (see paragraph below). The CRS scoring is computed for the major signal and the minor signal, for the most stringent filter level and for the least stringent filter level. The minor signal can be used to estimate alignment-induced signal noise (especially for the least stringent filter level). With the help of mtDNA databases such as mtradius (20), the major signal can be used to confirm the expected mtDNA type, and the minor signal can be used to detect potential human DNA contamination. The minor signal threshold in pibase_chrm_to_crs can be specified by the user (defaults: min 1.5% of the filtered coverage, min 2 reads).

When performing mitochondrial quality control or population genetics with reads mapped specifically to hg18, hg19, or NCBI36, there is a slight challenge: These reference genomes use the African sequence NC_{—}001807.4 (21) as the mitochondrial reference chrM. However, variants in the mitochondrial control region need to be accurately scored with respect to the CRS or to the revised CRS (rCRS) (22) in order to take advantage of the large existing forensic and population genetic mtDNA databases. This confusion arose because the mitochondrial genome community based its variant scoring and databases on the CRS or rCRS, whereas until recently the whole genome community used NC_{—}001807 as the mitochondrial reference sequence. In NCBI build 37 and in the future hg20, the revised CRS replaces NC_{—}001807. It should be mentioned that the CRS and the rCRS are identical in the control region (which is the region of interest for forensics and population genetics) and that they are numbered identically by the ploy of inserting an N at coordinate 3107.

The pibase_to_rdf and pibase_rdf_ref tools. The pibase_to_rdf tool translates a set of pibase_fisherdiff files into a binary rdf file. Variants are scored with respect to one sample in the set (which can optionally be a reference sample generated by the pibase_rdf_ref tool). For this reason, each pibase_fisherdiff file must use this sample as the control sample. If not generated by pibase_rdf_ref, the control sample should be well covered at the coordinates of interest. The user can specify the maximal p-value (above which samples are considered identical at a coordinate) and whether both-stranded confirmation is required to define a difference between samples at a coordinate. The rdf file is used as input for median joining network analysis. Phylogenetic network analysis is superior to principle component analysis in cases where it is meaningful to reconstruct ancestral types. One practical application for ancestral reconstruction is to screen for and identify potential patient/sample confusion (due to mislabeling or misreading tube labels in the laboratory or on the computer). The principle the inventors present here is to verify that a set of DNA profiles generated from (e.g. various DNA samples of) one patient (e.g. using various sequencing methods) all descend more closely from one common ancestor than from any other patient in the network. The practical ploy is to set ε=0 (i.e. the default in Network 4.6.1.0, available free at www.fluxus-engineering.com/sharenet.htm) to suppress the hyper-cubes which are expected in recombining data. The inventors especially see potential for the network method in the phylogenetic analysis of the variations of individual cells in a heterogeneous tumor sample (23).

### “Utility” Tools

The pibase_diff tool. pibase_diff is used for comparing samples conventionally (based on genotype differences, see Table 4, rows 2-4). The tool merges a case-control pair of pibase_consensus files, appending a filtering label for conventional genotype comparisons. These results are generally much less accurate than those of pibase_fisherdiff. The user needs to specify a threshold for the BestQual levels that should be included in the comparison.

The pibase_flagsnp tool. pibase_flagsnp flags non-reference genotypes as potential mismatches.

The pibase_genfromsnpacts tool. pibase_genfromsnpacts merges genotypes from a snpActs file into a pibase table, e.g. Sanger results, SNP-chip results, SAMtools results, and GATK results.

The pibase_to_vcf tool. pibase_to_vcf generates a VCF file, allowing submission of the pibase genotypes to the European Nucleotide Archives (http://www.ebi.ac.uk/ena/about/sra_submissions) and analysis by third party software such as VFCtools (5). Stable genotypes with both-stranded confirmation are flagged as “PASS” in the FILTER column, and all others as “FAIL”. The genotype quality values in the VCF file (GQ field) are computed as purely indicative values from the pibase confidence scores, using a conversion table which the user can optionally modify. For more specific information, the pibase BestQual scores are included (GQP field).

### Implementation

System requirements and installation instructions are listed under
http://www.ikmb.uni-kiel.de/pibase/index.html#tutorial. All tools were written in python (http://www.python.org/). The pibase_bamref tool requires the python module pysam
(http://code.google.com/p/pysam/downloads/list). The pibase_fisherdiff tool calls a FORTRAN77 program which uses algorithm 643 (18)
(http://portal.acm.org/citation.cfm?id=214326) (with the original workspace increased 1000× to 800 MB) and the DATAPAC library
(http://www.itl.nist.gov/div898/software/datapac/homepage.htm) and was compiled with the free GNU Fortran compiler (http://gcc.gnu.org/fortran/). The RAM memory footprint of the python tools was explicitly limited to 1 GB, and the FORTRAN77 program is limited to less than 1 GB.

The inventors have tested the tools on BAM data from the following pipelines and sequencing platforms: ABI SOLiD reads mapped with SOLiD Bioscope (v1.0.1 and v1.2.1) and BFAST (24), Illumina GA II and HiSeq 2000 reads mapped with BWA and SOAP (25) (after conversion using soap2sam.pl and SAMtools), and Roche 454/FLX reads mapped with BWA and SSAHA (26). The pibase tools have been tested within locally ongoing scientific research projects and further tools are being added to the pibase package as needed.

### Example Data

For our example data download, the inventors downloaded publicly available BAM files for chromosome 22 from ftp://ftp.1000genomes.ebi.ac.uk/vol1/ftp/data/ for the high coverage CEU trio (NA12878, daughter, NA12891, father, NA12892, mother). The daughter's whole genome BAM files were available with Illumina, SOLiD and 454/FLX reads, and the father's and mother's files were only available with Illumina reads. In the 1000 Genomes Project, the Illumina reads were mapped using BWA, the SOLiD reads using BFAST, and the 454/FLX reads using SSAHA.

The reference sequence used for mapping by the 1000 Genomes Project is available at ftp://ftp.sanger.ac.uk/pub/1000genomes/tk2/main_project_refer ence/human_g1k_v37.fasta.gz. This genome is largely the same as hg19, except that for example the chromosome names are changed to 1, 2, 3, etc, and the mitochondrial reference sequence is rCRS not chrM. The inventors supply the file hg19.1000G.quick.fasta in our example data download for use with chromosomes 1-22, X, and Y.

The inventors downloaded the file of exonic variant-calls (CEU.exon.2010_{—}03.genotypes.vcf.gz) from ftp://ftp.1000genomes.ebi.ac.uk/vol1/ftp/pilot_data/release/2 010_{—}07/exon/snps/. The VCF file lists only 55 SNVs for chromosome 22, and their genomic coordinates are counted with respect to hg18. The inventors transformed these SNV coordinates to hg19 coordinates using the online tool at http://genome.ucsc.edu/cgi-bin/hgLiftOver (27) and used them for the pibase analysis examples.

For further comparisons with established results and established tools, the inventors used pibase to re-call the HapMap SNPs defined in hapmap3_r1_b36_fwd.CEU.qc.poly.recode.map (ftp.ncbi.nlm.nih.gov/hapmap/phase_{—}3) after coordinate transformation from hg18/b36 to hg19. Furthermore, the inventors re-called SNVs in chromosome 22 using both GATK and SAMtools (mpileup, bcftools, vcfutils), merged the GATK and SAMtools SNV-lists (i.e. union of both SNV-lists, not overlap) using snpActs, and re-called these SNVs using pibase. The inventors compared all re-called SNVs with the HapMap SNPs in hapmap3_r1_b36_fwd.CEU.qc.poly.recode.ped to assess the levels of specificity. Finally, using snpActs, the inventors performed Mendelian error checks for the SNV-lists from the Illumina trio data, to further compare the levels of specificity. The inventors documented the settings for each tool in the shell scripts which are included in our example data download (subfolders chr22_snpcalling and chr22_scripts).

### SNV Differences in Identical Twins

As part of an ongoing research project, the exomes of two German twin pairs were analyzed. The Agilent SureSelect Human All Exon v2 Kit was used for capturing 48 Mb of target regions. The four exome samples were each sequenced on a quadrant of a quartet slide on the SOLiD v4 platform using paired end reads (50 by forward, 35 by reverse). The reads were mapped using Bioscope 1.2.1. Duplicate reads were removed from the BAM files using Picard. SNVs were called using Bioscope 1.2.1 and also SAMtools (pileup), resulting in four SNV lists per twin pair. These four SNV-lists per twin pair were merged, and pibase was used to interrogate each of these genomic coordinates in each twin of that pair. Finally, pibase was used for two different methods of comparison: the first method using conventional genotype comparison after interrogating the BAM files (pibase_diff) and the second method using Fisher's exact test of nucleotide signals at 5 different filter levels in the BAM files (pibase_fisherdiff).

### Median Joining Network Analysis

To demonstrate how to check for potential sample confusion if an insufficient number of discriminating SNVs is available, the inventors applied median joining network analysis (16) to compare the five example 1000 Genomes BAM files, comprising two parents sequenced on Illumina, and their daughter sequenced on Illumina, SOLiD, and FLX/454. The inventors used the daughter's Illumina BAM file as the control or reference sample. The inventors used pibase_bamref followed by pibase_consensus for each sample. The inventors then performed pibase_fisherdiff comparisons between the control sample and each of the remaining samples at the 55 genomic coordinates. The inventors used pibase_to_rdf to generate the rdf files setting p.med ≦0.2 without requesting both-stranded confirmation. The inventors used Network 4.6.0.0 to compute the median joining networks using default settings. Network accepts five main input data formats: “binary” format (1/0 or difference/no difference), “multistate” DNA format (A, C, G, T, N, -), “multistate” amino acid format (A, B, C, D, etc.), “RFLP” format, and “Y-STR” format (counts of a repetitive marker motif at a site). pibase_to_rdf can generate the binary format (which is the most efficient format for handling large data sets) and resolves the challenge of defining a difference/no difference criterion for diploid genomic genotype data.

Using pibase, the inventors obtained highly specific (99.98%-99.99%) genotype calls from publicly available Illumina GA II BAM files as detailed below in the 1000 Genomes Project example section. The inventors also demonstrate significantly shorter run times to validate genotypes at the specified list of known HapMap SNP coordinates than is required by samtools or GATK for a complete SNP-calling run on chromosome 22. Furthermore, the inventors report that the false discovery rate of SNV differences in pairs of monozygotic twins is ten-fold lower using pibase's Fisher's exact test than using a genotype-based comparison method. Finally, the inventors show that pibase can be used in combination with a phylogenetic network method to sort out potential sample confusions using a set of only 55 SNVs.

### Example Data From the 1000 Genomes Project

Tables 1a, 1b, and 2 show the principles using selected (and simplified) results from pibase_bamref, pibase_consensus, and pibase_fisherdiff. Complete results for five BAM files are available under www.ikmb.uni-kiel.de/pibase/output_validated.zip and the settings used for obtaining these results are available as a shell script under www.ikmb.uni-kiel.de/pibase/pibase_test.html. This first set of example results files is small enough for Windows users to easily load into Excel. In brief, the runtime for the shell script on a single core of an AMD Shanghai 2.4 GHz processor was 17 seconds to interrogate the five BAM files and the reference sequence, compute genotypes at the 55 coordinates in each BAM file, and compare the Illumina BAM file of the daughter with the Illumina BAM file of her father at two different stringencies. Assuming manual inspection and documentation time for 275 SNVs at 3 minutes per SNV (or 56,100 seconds for 275 SNVs), the pibase validation run is about 3000× faster than our in-house manual inspection and documentation process. In other studies, the inventors manually inspected and documented BAM files in IGV at a speed of about 60-100 SNVs per day. It should be noted that pibase is suitable for validating SNV lists from an entire exome (Table 4) within a few hours or less on a single CPU, and the ca. 3 million SNVs in a human genome within about 60 hours on a single CPU.

As Table 1b exemplifies, BestGen genotypes and BestQual qualities correctly reflect the quality of genotypes and can provide a good estimate of the genotype if the BestQual is good, if both strands support the genotype, and if the SNV is not within proximity of indels (which can be filtered using the Linux commands grep and awk or Microsoft Excel), and further provided that the control parameters were set as recommended (see Methods and Materials section).

Table 2 exemplifies the results from a sample comparison using pibase_fisherdiff, showing that genotype differences can be detected correctly using the median of the five two-tailed p-values, which are computed using the 2×4 Fisher's exact test on the unique start point counts for each of the five pibase_bamref filter levels. The relatively high p-value of 0.0464 for chr22:19968971 reflects the fairly low coverage (only 17× at filter level 0) in combination with a fairly small shift in allelic counts (from 17×G in the father to 5×A, 11×G in the daughter). To detect differences with high confidence, coverages should generally be more like 50×, e.g. for chr22:30953295 the p-value is 8.4×10-6, and the daughter's coverage is 35×.

Furthermore, the inventors re-analyzed all 19,600 HapMap SNPs on chromosome 22 to compare the specificity of pibase with GTAK and SAMtools, using the published non-reference HapMap SNPs as the gold standard. Each sample was analyzed on a linux cluster, requiring only a single CPU per run. The run times were only 4-10 minutes per sample using pibase, 17-55 minutes per sample using SAMtools, and about 5 hours per sample using GATK. The “stable” pibase SNP-calls (diagnostic quality SNP-calls) for the Illumina GA II sequencing runs were 99.98%-99.99% accurate, compared to ˜99.6% for GATK or SAMtools. Our analysis also showed that about 20 of 19,600 HapMap genotypes per family trio member in the published data (hapmap3_r1_b36_fwd.CEU.qc.poly.recode.ped) were affected by strand mix-ups. The inventors had previously also confirmed such strand mix-ups in the published data for HapMap individual NA12752 using Sanger sequencing (ElSharawy et al, manuscript in revision). The results are summarized in Supplementary Table 1 and full results (sum_snpgen_in_excel.zip, ˜84 MB, 5 Excel files) are included in the example data on the pibase homepage.

Finally, the inventors used GATK and SAMtools to detect non-reference SNVs on chromosome 22, merged the SNV lists, and used pibase to re-analyze the BAM-files at these SNV positions. Using snpActs, the inventors computed the Mendelian inheritance errors within the CEU family trio. The “stable” pibase SNV-calls yielded only 8 (0.02%) SNVs with Mendelian errors, whereas the SNV-calls from SAMtools, GATK, and the union of SAMtools+GATK resulted in 78 (0.19%), 108 (0.24%), and 114 (0.25%) Mendelian errors, respectively. The inventors expected about one true Mendelian error on chromosome 22, as the reported de novo mutation rate from parents to their offspring is about 66 SNVs in a whole genome (28).

### SNV Differences in Identical Twins (FDRs)

The false discovery rate (FDR) of genotype differences is exemplified in Table 4. The inventors sequenced the exomes of two pairs of monozygotic twins and considered SNV positions called by two SNV callers (Bioscope and SAMtools pileup). After filtering, about 800 apparent differences remained per twin pair. The inventors validated that the apparent genotype differences between the called variants were only SNV-calling artifacts, i.e. that the 65,654 genotypes in twin pair 1 were shared by both twins, and that the 67,997 genotypes in twin pair 2 were shared as well by the twins. Using pibase_diff for a simple conventional genotype comparison at the 65,654 and 67,997 coordinates, respectively, the number of false positive genotype differences was 2047 (in pair 1) and 1864 (in pair 2) if low quality genotypes with BestQual ?2 were included, 527 and 470 if BestQual ?1 was included, and 55 and 72 if only the best quality genotypes were used. However, using pibase_fisherdiff for a Fisher's exact test analysis at the 65,654 and 67,997 coordinates, respectively, clearly shows a ten-fold improvement: For example at p-values <0.01, only 5 and 15 genotype differences are indicated. The inventors expected to find between zero and one differences in the exomes of twins, assuming that their differences would be on a similar order of magnitude as the recently published rates of de novo mutations in exomes from parents to their offspring (29).

### Phylogenetic Screening for Sample Confusion

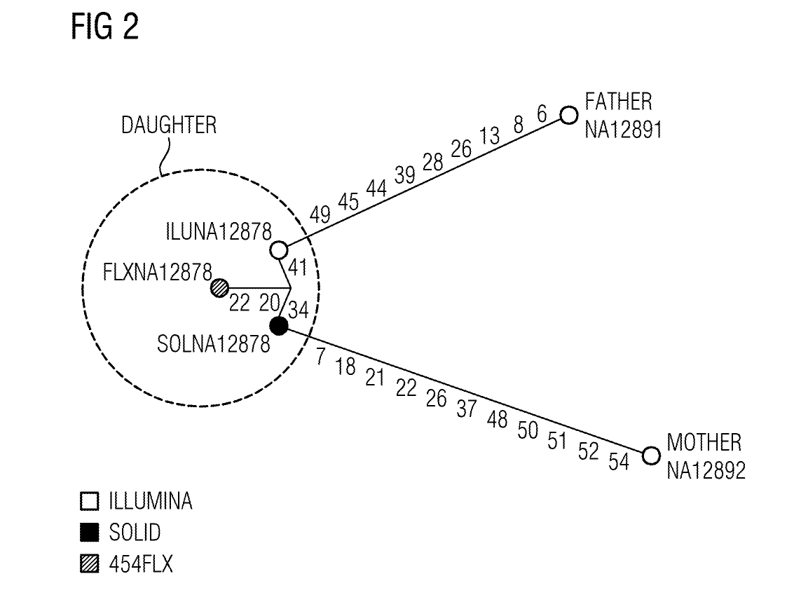

To exemplify detection of potential sample confusions using our “phylogenetics workflow”, the inventors compared the BAM-files of a European family trio published by the 1000 Genomes Project, i.e. the five BAM files in our example download. Setting out with three BAM files for the daughter and one each for the parents, the inventors used the pibase tools to generate input data for the phylogenetic network software Network 4.6.0.0. The phylogenetic network (FIG. 2) shows that the daughter's three genotypes (from the three different platforms Illumina, SOLiD, 454/FLX) cluster together as expected, whereas there are significant differences between the daughter nodes versus the father node and the mother node. This phylogenetic approach is novel in next-generation sequencing and, unsurprisingly, shows that in this case no samples have been confused. The inventors have applied this approach successfully in a real ongoing targeted sequencing experiment comprising a panel of patients from whom two tissue samples each were sequenced (i.e. unaffected tissue and affected tissue).

The inventors here present a set of methods which can be implemented as software tools (herein also referred to as “pibase”) which extract data directly from BAM files at user-specified genomic coordinates in order to perform rule-based genotyping at these coordinates with a high specificity (99.98%-99.99% in our examples), and optionally pairwise sample comparisons at these genomic coordinates using Fisher's exact test. The pibase tools are designed for postprocessing after the typical standard pipelines (FIG. 1) and can be integrated into these existing pipelines as back-end add-ons. The pibase tools can generate detailed reports for non-bioinformatician recipients which are transparent, accurate, easy to understand, and to use, and which therefore convey confidence. Recipients who will benefit are clinicians who need to make decisions based on a set of SNVs, forensic investigators, archaeogeneticists performing dating, or researchers who are evaluating the NGS experiments in detail, especially in the context of comparative analyses and phylogenetic analyses.

Within a pipeline, pibase can also be used for automated quality control purposes, including the rapid validation of previously called SNVs, i.e. filtering stable genotypes from instable genotypes by re-evaluating the original BAM file at SNV coordinates of interest. It should be mentioned that pibase does not analyze indels, but it indicates that an indel may be at or near a SNV locus. The pibase software complements front-end QC tools such as FASTQC (which checks the quality of sequence reads before alignment), and probabilistic back-end QC tools such as VQSR (which eliminates false positive SNV-calls using a large data set of “true data” and a large data set of SNV-calls), and viewers such as IGV. Whereas VQSR needs a large SNV data set and a training data set and uses a Bayesian model to eliminate called SNVs, pibase can rapidly interrogate a list of genomic coordinates (regardless of whether there is a mismatch at this coordinate or not) and uses deterministic rules similar to an exceedingly thorough IGV inspection with comprehensive filtering.

Our reads filtering approach allows sufficient user control to be flexible and is transparent. Such filtering is generally performed by bioinformaticians, so that biologists are seldom aware of the process or the implications when they receive the data. Biologists who are interested in reads filtering may consult www.ikmb.uni-kiel.de/pibase/pibase_filtering.html. In brief, when DNA sequencing data are mapped to conserved regions of hg18 or hg19, the inventors would usually expect about one SNV per 1000 base positions (30), especially if the samples come from Central European individuals, and therefore recommend a pibase_bamref filter ceiling of one mismatch per read. By contrast, reads mapped to hyper-variable regions or to a dissimilar reference sequence can be inaccurate, which becomes noticeable in poor pibase_consensus “BestQual” labels. The African chrM sequence is an example of a genome with a hyper-variable region, which prompted us to develop the pibase_chrm_to_crs tool for scoring variants in the human mitochondrial control region.

The pibase software also facilitates data extraction for phylogenetic analyses and phylogenetic QC, e.g. sample swap quality control (FIG. 2), identity confirmation and sequencing accuracy checks using expected mtDNA haplotypes (3, 31), and contamination detection by checking for heteroplasmy outside the known evolutionary mtDNA hotspots (17) and for implausible mtDNA haplotypes.

For sample comparisons, our Fisher's exact test approach overcomes the heterozygosity/homozygosity determination problem of genotype-based comparisons, and is furthermore able to detect shifts in allelic balances of heterozygous genotypes which can occur in heterogeneous tumor samples or in the presence of a copy number variation.

Lastly, pibase allows researchers with bioinformatic skills but without high performance computing facilities to extract genotype data of interest from publicly available next-generation sequencing BAM files for their own research projects, regardless of which bioinformatic frameworks and options were used to produce the BAM files. The software, example data, and documentation are freely accessible under http://www.ikmb.uni-kiel.de/pibase.

REFERENCES: The entire contents of each of the following references are hereby incorporated herein by reference.

1. Ewing, B., Hillier, L., Wendl, M. C. and Green, P. (1998) Base-calling of automated sequencer traces using phred. I. Accuracy assessment. Genome research, 8, 175-85.

2. Li, H. and Durbin, R. (2009) Fast and accurate short read alignment with Burrows-Wheeler transform. Bioinformatics (Oxford, England), 25, 1754-60, 10.1093/bioinformatics/btp324.

3. A map of human genome variation from population-scale sequencing. (2010) Nature, 467, 1061-73, 10.1038/nature09534.

4. Li, H., Handsaker, B., Wysoker, A., Fennell, T., Ruan, J., Homer, N., Marth, G., Abecasis, G. and Durbin, R. (2009) The Sequence Alignment/Map format and SAMtools. Bioinformatics (Oxford, England), 25, 2078-9, 10.1093/bioinformatics/btp352.

5. Danecek, P., Auton, A., Abecasis, G., Albers, C. a, Banks, E., Depristo, M. a, Handsaker, R., Lunter, G., Marth, G., Sherry, S. T., et al. (2011) The Variant Call Format and VCFtools. Bioinformatics (Oxford, England), 27, 2156-2158, 10.1093/bioinformatics/btr330.

6. DePristo, M. A., Banks, E., Poplin, R., Garimella, K. V., Maguire, J. R., Hartl, C., Philippakis, A. A., del Angel, G., Rivas, M. A., Hanna, M., et al. (2011) A framework for variation discovery and genotyping using next-generation DNA sequencing data. Nature genetics, 43, 491-8, 10.1038/ng.806.

7. Robinson, J. T., Thorvaldsdóttir, H., Winckler, W., Guttman, M., Lander, E. S., Getz, G. and Mesirov, J. P. (2011) Integrative genomics viewer. Nature biotechnology, 29, 24-6, 10.1038/nbt.1754.

8. Goecks, J., Nekrutenko, A. and Taylor, J. (2010) Galaxy: a comprehensive approach for supporting accessible, reproducible, and transparent computational research in the life sciences. Genome biology, 11, R86, 10.1186/gb-2010-11-8-r86.

9. Blankenberg, D., Von Kuster, G., Coraor, N., Ananda, G., Lazarus, R., Mangan, M., Nekrutenko, A. and Taylor, J. (2010) Galaxy: a web-based genome analysis tool for experimentalists. Current protocols in molecular biology/edited by Frederick M. Ausubel . . . [et al.], Chapter 19, Unit 19.10.1-21, 10.1002/0471142727.mb1910s89.

10. McKenna, A., Hanna, M., Banks, E., Sivachenko, A., Cibulskis, K., Kernytsky, A., Garimella, K., Altshuler, D., Gabriel, S., Daly, M., et al. (2010) The Genome Analysis Toolkit: a MapReduce framework for analyzing next-generation DNA sequencing data. Genome research, 20, 1297-303, 10.1101/gr.107524.110.

11. Blankenberg, D., Gordon, A., Von Kuster, G., Coraor, N., Taylor, J. and Nekrutenko, A. (2010) Manipulation of FASTQ data with Galaxy. Bioinformatics (Oxford, England), 26, 1783-5, 10.1093/bioinformatics/btq281.

12. Purcell, S., Neale, B., Todd-Brown, K., Thomas, L., Ferreira, M. A. R., Bender, D., Maller, J., Sklar, P., de Bakker, P. I. W., Daly, M. J., et al. (2007) PLINK: a tool set for whole-genome association and population-based linkage analyses. American journal of human genetics, 81, 559-75, 10.1086/519795.

13. Koboldt, D. C., Chen, K., Wylie, T., Larson, D. E., McLellan, M. D., Mardis, E. R., Weinstock, G. M., Wilson, R. K. and Ding, L. (2009) VarScan: variant detection in massively parallel sequencing of individual and pooled samples. Bioinformatics (Oxford, England), 25, 2283-5, 10.1093/bioinformatics/btp373.

14. Melum, E., May, S., Schilhabel, M. B., Thomsen, I., Karlsen, T. H., Rosenstiel, P., Schreiber, S. and Franke, A. (2010) SNP discovery performance of two second-generation sequencing platforms in the NOD2 gene region. Human mutation, 31, 875-85, 10.1002/humu.21276.

15. Bansal, V. (2010) A statistical method for the detection of variants from next-generation resequencing of DNA pools. Bioinformatics (Oxford, England), 26, i318-24, 10.1093/bioinformatics/btq214.

16. Bandelt, H. J., Forster, P. and Röhl, A. (1999) Median-joining networks for inferring intraspecific phylogenies. Molecular biology and evolution, 16, 37-48.

17. Forster, L., Forster, P., Gurney, S. M. R., Spencer, M., Huang, C., Röhl, A. and Brinkmann, B. (2010) Evaluating length heteroplasmy in the human mitochondrial DNA control region. International journal of legal medicine, 124, 133-42, 10. 1007/s00414-009-0385-0.

18. Mehta, C. R. and Patel, N. R. (1986) ALGORITHM 643: FEXACT: a FORTRAN subroutine for Fisher's exact test on unordered r×c contingency tables. ACM Transactions on Mathematical Software, 12, 154-161, 10.1145/6497.214326.

19. Anderson, S., Bankier, A. T., Barrell, B. G., de Bruijn, M. H., Coulson, A. R., Drouin, J., Eperon, I. C., Nierlich, D. P., Roe, B. A., Sanger, F., et al. (1981) Sequence and organization of the human mitochondrial genome. Nature, 290, 457-465.

20. Röhl, A., Brinkmann, B., Forster, L. and Forster, P. (2001) An annotated mtDNA database. International journal of legal medicine, 115, 29-39.

21. Ingman, M., Kaessmann, H., Pääbo, S. and Gyllensten, U. (2000) Mitochondrial genome variation and the origin of modern humans. Nature, 408, 708-13, 10.1038/35047064.

22. Andrews, R. M., Kubacka, I., Chinnery, P. F., Lightowlers, R. N., Turnbull, D. M. and Howell, N. (1999) Reanalysis and revision of the Cambridge reference sequence for human mitochondrial DNA. Nature genetics, 23, 147, 10.1038/13779.

23. Navin, N., Kendall, J., Troge, J., Andrews, P., Rodgers, L., Mclndoo, J., Cook, K., Stepansky, A., Levy, D., Esposito, D., et al. (2011) Tumour evolution inferred by single-cell sequencing. Nature, 472, 90-4, 10. 1038/nature09807.

24. Homer, N., Merriman, B. and Nelson, S. F. (2009) BFAST: an alignment tool for large scale genome resequencing. PloS one, 4, e7767, 10.1371/journal.pone.0007767.

25. Li, R., Yu, C., Li, Y., Lam, T.-W., Yiu, S.-M., Kristiansen, K. and Wang, J. (2009) SOAP2: an improved ultrafast tool for short read alignment. Bioinformatics (Oxford, England), 25, 1966-7, 10.1093/bioinformatics/btp336.

26. Ning, Z., Cox, A. J. and Mullikin, J. C. (2001) SSAHA: a fast search method for large DNA databases. Genome research, 11, 1725-9, 10.1101/gr.194201.

27. Kent, W. J., Sugnet, C. W., Furey, T. S., Roskin, K. M., Pringle, T. H., Zahler, A. M. and Haussler, D. (2002) The human genome browser at UCSC. Genome research, 12, 996-1006, 10.1101/gr.229102. Article published online before print in May 2002.

28. Roach, J. C., Glusman, G., Smit, A. F. a, Huff, C. D., Hubley, R., Shannon, P. T., Rowen, L., Pant, K. P., Goodman, N., Bamshad, M., et al. (2010) Analysis of genetic inheritance in a family quartet by whole-genome sequencing. Science (New York, N.Y.), 328, 636-9, 10.1126/science.1186802.

29. Girard, S. L., Gauthier, J., Noreau, A., Xiong, L., Zhou, S., Jouan, L., Dionne-Laporte, A., Spiegelman, D., Henrion, E., Diallo, O., et al. (2011) Increased exonic de novo mutation rate in individuals with schizophrenia. Nature genetics, 43, 860-863, 10.1038/ng.886.

30. Pelak, K., Shianna, K. V., Ge, D., Maia, J. M., Zhu, M., Smith, J. P., Cirulli, E. T., Fellay, J., Dickson, S. P., Gumbs, C. E., et al. (2010) The characterization of twenty sequenced human genomes. PLoS genetics, 6, 10.1371/journal.pgen.1001111.

31. Bandelt, H.-J. and Salas, A. (2011) Current Next Generation Sequencing technology may not meet forensic standards. Forensic science international. Genetics, 3-5, 10.1016/j.fsigen.2011.04.004.

### Tables

TABLE 1a
Surviving reads after successive
filtering, at four positions in a public BAM file

| | | Filter | | Filter | | Filter | | Filter | | Filter | |
|---|---|---|---|---|---|---|---|---|---|---|---|
| Genomic | Raw | 0 | | 1 | | 2 | | 3 | | 4 | |
| coordinate | CV | CV | SP | CV | SP | CV | SP | CV | SP | CV | SP |
| chr22: 19969075 | 6 | 3 | 3 | 0 | 0 | 0 | 0 | 0 | 0 | 0 | 0 |
| chr22: 19969495 | 14 | 11 | 8 | 8 | 6 | 3 | 2 | 3 | 2 | 3 | 2 |
| chr22: 30857373 | 8 | 5 | 5 | 2 | 2 | 1 | 1 | 1 | 1 | 1 | 1 |
| chr22: 31491295 | 17 | 7 | 7 | 4 | 4 | 3 | 3 | 2 | 2 | 2 | 2 |

Table 1a demonstrates pibase filtering and the resulting coverage. Filtering improves genotyping accuracy by eliminating potential errors in the raw reads and the alignments, but at the cost of reducing the number of surviving reads. In this table, filtering stringency increases from left to right. CV: number of (all) reads covering this genomic coordinate, SP: remaining reads after filtering away reads with the same start points. Coverage is not uniform over the genome, making the identification of some genotypes less confident than others (see Table lb). The data in this table refer to the NA12878 SOLiD BAM file in our example data download. The genomic coordinates are based on hg19, and the starting coordinate is counted from one.

TABLE 1b
Stable and instable genotypes resulting
from the filtering in Table 1a

| Genomic | Gold | Consensus | | Filter 0 | | Filter 2 | | Filter 4 | |
|---|---|---|---|---|---|---|---|---|---|
| coordinate | standard | BG | Quality | CV | SP | CV | SP | CV | SP |
| chr22: 19969075 | AG | AA | FAIL | AA | AA | | | | |
| chr22: 19969495 | GG | GG | PASS | GG | GG | GG | GG | GG | GG |
| chr22: 30857373 | AC | AC | FAIL | AC | AC | CC | CC | CC | CC |
| chr22: 31491295 | CG | CG | FAIL | CG | CG | CC | CC | | |

Table 1b shows the gold standard genotypes, and the genotypes and quality grades inferred by pibase, corresponding to the different coverages in Table 1a. Gold standard: The 1000 Genomes Project's consensus of three sequencing platforms (Illumina, SOLiD, FLX/454). Consensus: rule-based consensus over all pibase filter levels, BG: consensus genotype. The consensus genotypes in lines one, three and four were inferred from low coverage or filtering ambiguities, and marked as a failure because this quality is not acceptable in clinical diagnostics. By contrast, the genotype in the second line is unambiguous over all filters and confirmed by sufficient reads.

TABLE 2
Discrimination of non-identical SNVs in
BAM file pairs using Fisher's exact test

| Genomic | p-value | Best Genotype | |
|---|---|---|---|
| coordinate | (from read counts) | NA12878 | NA12891 |
| chr22: 19968971 | 0.0464 | AG | GG |
| chr22: 30953295 | 8.4 × 10⁻⁶ | TT | CC |
| chr22: 39440149 | 0.0161 | CT | TT |
| chr22: 40417780 | 0.0009 | CC | CT |

Table 2 illustrates that the two-tailed p-value obtained from Fisher's exact test is well suitable for discriminating identical genotypes from non-identical genotypes in BAM-files. Here the inventors show Illumina NA12878 and NA12891 bam files from our example download, with coverages between 6× and 37×. A typical application is the pair-wise comparison of affected and unaffected twin (see Table 4), or of tumor tissue and normal tissue. p-value: from Fisher's exact test on the number of unique start points for each filter level, indicating the probability of the sample pair having the same genotype at this specific genomic coordinate. For difficult genotype calls (i.e. read count between heterozygosity and homozygosity states or for low coverage genotypes) and when comparing heterogeneous tumor samples, the p-value is a more accurate metric for identifying pairwise sample differences than a comparison of SNV-calls or genotypes.

TABLE 3
Categorization of instable SNV-calls using SNV label
(BestQual) for classifying a degree of (low) quality

| Label | Explanation |
|---|---|
| ?1 | Mapping stringency versus reference sequence context |
| | class is good. Not all 10 genotyping filter stages lead |
| | to the same genotype. However, for the high mapping |
| | stringency filter stages, at least n1 unique start points |
| | and at least n2 reads support this genotype (defaults: |
| | n1 = 4, n2 = 8). |
| ?2 | Mapping stringency versus reference sequence context |
| | class is good. This genotype is supported by less than 5 |
| | filter stages, but by at least 2 filter stages, of which |
| | one stage is in the unique start points category, and the |
| | other stage is in the coverage category. |
| ?3 | Poor quality. Low complex reference sequence context |
| | (homopolymericrun >4, or STRs, i.e. short tandem repeats) |
| | and low mapping stringency but at least one stringent |
| | filter supports this genotype. |
| ?4 | Very poor quality. Low complex reference sequence context |
| | (homopolymeric run >4, or STRs) and mapping stringency |
| | was low. But at least one of the unique-start-point filters |
| | supports this genotype. |
| ?5 | Highly problematic quality. The best unique-start-point |
| | derived genotype is in conflict with the best coverage- |
| | derived genotype. |
| ?6 | Highly problematic quality. The best unique-start-point |
| | derived genotype is in conflict to the best coverage- |
| | derived genotype, and the best coverage-derived genotype |
| | is “superior” to the best unique-start-point-derived genotype. |
| ?7 | Low-coverage guess. The coverage is less than n2 (default: |
| | n2 = 8). |
| ?8 | Low-coverage guess. The coverage is less than n2 (default: |
| | n2 = 8), low complex reference sequence context (homopolymeric |
| | run >4, or STRs), and there are no stringently |
| | mappable reads. |

TABLE 4
False discovery rate of differences in
exomes of identical, monozygotic twins

| | Pair 1 | FDR | Pair 2 | FDR |
|---|---|---|---|---|
| SNVs called | 65654 | | 67997 | |
| Genotype differences (?2) | 2047 | 3.12% | 1864 | 2.74% |
| Genotype differences (?1) | 527 | 0.80% | 470 | 0.69% |
| Genotype differences (stable) | 55 | 0.08% | 72 | 0.11% |
| FET differences (p < 0.05) | 135 | 0.21% | 169 | 0.28% |
| FET differences (p < 0.04) | 92 | 0.14% | 125 | 0.18% |
| FET differences (p < 0.03) | 48 | 0.07% | 74 | 0.11% |
| FET differences (p < 0.02) | 25 | 0.04% | 51 | 0.08% |
| FET differences (p < 0.01*) | 5 | 0.01% | 15 | 0.02% |

This table shows the apparent differences within two twin pairs, as a function of the comparison method (genotype comparison vs. Fisher's exact test) and the comparison stringency. Manual inspection of aligned reads at the coordinates of potential genotype differences showed zero differences within each pair. FDR: number of computed differences divided by the number of SNVs called. Genotype differences: numbers of SNV-differences including instable genotype pairs (labels “?2” and “?1”) and using only the stable genotype pairs. FET differences: Fisher's exact test based differences computed by pibase_fisherdiff and filtered for p-value thresholds of 0.01 (*recommended setting), 0.02, 0.03, 0.04. 0.05. All results shown reflect filtering for both-stranded confirmation of genotypes.

### Supplementary Tables:

Supplementary tables 1a-1e summarize sensitivity (overlap with HapMap) and specificity (concordance with HapMap) of SNVs called by SAMtools, GATK, and pibase, for five different BAM-files from publicly available 1000 Genomes Project data, which the inventors include in our example data download (http://www.ikmb.uni-kiel.de/pibase). The settings for SAMtools and GATK are documented in the scripts in subfolder chr22_snpcalling, and the settings for pibase in the scripts in subfolder chr22_scripts.

SUPPLEMENTARY TABLE 1a
Genotypes reported for NA12878 (daughter) in Illumina BAM file

| | HapMap | SAMtools | GATK | pibase all | pibase stable |
|---|---|---|---|---|---|
| All HapMap SNPs | 19600 | — | — | 19592 | 19163 |
| Non-Ref HapMap SNPs (and overlap) | 9891 | 9668 | 9685 | 9808 | 9411 |
| Discordant SNPs (nominal) | — | 31 | 34 | 237 | 23 |
| Discordant SNPs (corrected)* | — | 10 | 13 | 216 | 2 |
| Concordance in % | | 99.90% | 99.87% | 97.80% | 99.98% |
| Concordant SNPS (nominal) | — | 9637 | 9651 | 9571 | 9388 |
| Concordant SNPs (corrected)* | — | 9658 | 9672 | 9592 | 9409 |
| Not-callable SNPs | — | 223 | 206 | 83 | 480 |

*corrected for potential strand mix-up in HapMap chip data: see pibase homepage
example data download, subfolder chr22_hapmap_summarytables,
zipfile sum_snpgen_in_excel.zip, file
sum_snpgen_na12878_illu_manualcounts.xlsx.

| | |
|---|---|
| Best false negative rate between SAMtools and GATK: | 2.1% |
| Worst false negative rate between SAMtools and GATK: | 2.4% |
| pibase false negative rate**: | 0.8% |

**i.e. no genotype. But pibase reports read counts everywhere

SUPPLEMENTARY TABLE 1b
Genotypes reported for NA12891 (father) in Illumina BAM file

| | HapMap | SAMtools | GATK | pibase all | pibase stable |
|---|---|---|---|---|---|
| All HapMap SNPs | 19643 | — | — | 19633 | 18921 |
| Non-Ref HapMap SNPs (and overlap) | 9719 | 9490 | 9519 | 9677 | 9033 |
| Discordant SNPs (nominal) | — | 34 | 38 | 336 | 20 |
| Discordant SNPs (corrected)* | — | 15 | 19 | 317 | 1 |
| Concordance in % | | 99.84% | 99.80% | 96.72% | 99.99% |
| Concordant SNPS (nominal) | — | 9456 | 9481 | 9341 | 9013 |
| Concordant SNPs (corrected)* | — | 9475 | 9500 | 9360 | 9032 |
| Not-callable HapMap SNPs | — | 229 | 200 | 42 | 686 |

*corrected for potential strand mix-up in HapMap chip data: see Supplementary File
sum_snpgen_na12891_illu_manualcounts.xlsx.

| | |
|---|---|
| Best false negative rate between SAMtools and GATK: | 2.1% |
| Worst false negative rate between SAMtools and GATK: | 2.4% |
| pibase false negative rate**: | 0.4% |

SUPPLEMENTARY TABLE 1c
Genotypes reported for NA12892 (mother) in Illumina BAM file

| | HapMap | SAMtools | GATK | pibase all | pibase stable |
|---|---|---|---|---|---|
| All HapMap SNPs | 19637 | — | — | 19608 | 18423 |
| Non-Ref HapMap SNPs (and overlap) | 10097 | 9738 | 9882 | 10029 | 9016 |
| Discordant SNPs (nominal) | — | 47 | 45 | 465 | 19 |
| Discordant SNPs (corrected)* | — | 30 | 28 | 448 | 2 |
| Concordance in % | | 99.69% | 99.72% | 95.53% | 99.98% |
| Concordant SNPS (nominal) | — | 9691 | 9777 | 9564 | 8997 |
| Concordant SNPs (corrected)* | — | 9708 | 9794 | 9581 | 9014 |
| Not-callable HapMap SNPs | — | 359 | 215 | 68 | 1081 |

*corrected for potential strand mix-up in HapMap chip data: see Supplementary File
sum_snpgen_na12892_illu_manualcounts.xlsx.

| | |
|---|---|
| Best false negative rate between SAMtools and GATK: | 2.1% |
| Worst false negative rate between SAMtools and GATK: | 3.6% |
| pibase false negative rate**: | 0.7% |

| | | | | |
|---|---|---|---|---|
| Median concordance within Supplementary | 99.84% | 99.80% | 96.72% | 99.98% |
| Tables 1a-1c | | | | |

SUPPLEMENTARY TABLE 1d
Genotypes reported for NA12878 (daughter) in SOLiD BAM file

| | HapMap | SAMtools | GATK | pibase all | pibase stable |
|---|---|---|---|---|---|
| All HapMap SNPs | 19600 | — | — | 19189 | 4563 |
| Non-Ref HapMap SNPs (and overlap) | 9891 | 4718 | 3986 | 9525 | 651 |
| Discordant SNPs (nominal) | — | 1062 | 650 | 4870 | 5 |
| Discordant SNPs (corrected)* | — | 1059 | 647 | 4867 | 2 |
| Concordant SNPS (nominal) | — | 3656 | 3336 | 4655 | 646 |
| Concordant SNPs (corrected)* | — | 3659 | 3339 | 4658 | 649 |
| Not-callable HapMap SNPs | — | 5173 | 5905 | 366 | 9240 |

*corrected for potential strand mix-up in HapMap chip data: see Supplementary File
sum_snpgen_na12878_solid_manualcounts.xlsx.

| | |
|---|---|
| Best false negative rate between SAMtools and GATK: | 52.3% |
| Worst false negative rate between SAMtools and GATK: | 59.7% |
| pibase false negative rate**: | 3.7% |

**i.e. no genotype. But pibase reports read counts everywhere

SUPPLEMENTARY TABLE 1e
Genotypes reported for NA12878 (daughter) in FLX BAM file

| | HapMap | SAMtools | GATK | pibase all | pibase stable |
|---|---|---|---|---|---|
| All HapMap SNPs | 19600 | — | — | 19076 | 3055 |
| Non-Ref HapMap SNPs (and overlap) | 9891 | 9318 | 9099 | 9371 | 1144 |
| Discordant SNPs (nominal) | — | 92 | 97 | 3924 | 47 |
| Discordant SNPs (corrected)* | — | 86 | 91 | 3918 | 41 |
| Concordant SNPS (nominal) | — | 9226 | 9002 | 5447 | 1097 |
| Concordant SNPs (corrected)* | — | 9232 | 9008 | 5453 | 1103 |
| Not-callable HapMap SNPs | — | 573 | 792 | 520 | 8747 |

*corrected for potential strand mix-up in HapMap chip data: see Supplementary File
sum_snpgen_na12891_illu_manualcounts.xlsx.

| | |
|---|---|
| Best false negative rate between SAMtools and GATK: | 5.8% |
| Worst false negative rate between SAMtools and GATK: | 8.0% |
| pibase false negative rate**: | 5.3% |

**i.e. no genotype. But pibase reports read counts everywhere

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for validation of single nucleotide variants (SNV) in a sequence of interest, comprising:
interrogating a BAM-file of said sequence of interest and a reference sequence file of said sequence of interest and producing a summary table for genomic coordinates of interest;
generating a plurality of sequence reads from a sample of said sequence of interest;
filtering sequence reads using a plurality of filter levels;
extracting SNV counts for A, C, G, T, N for each strand for a genomic region of interest within said sequence of interest, resulting in ten SNV counts;
determining, for each genomic region of interest, a rule based genotype decision and inferring a best genotype from the 10 counts, and
creating a single consensus file for said sequence of interest comprising information of best genotype and a best quality for each genomic region of interest.

2. The method of claim 1, wherein five filter levels are used and wherein the first filter level removes reads with insertions and/or deletions, the second filter level comprises a base quality filter, the third level comprises a mapped length filter, the fourth level comprises a mismatches-per-read filter, and the fifth level comprises a mapping quality filter.

3. The method of claim 1, wherein said rule based genotype decision comprises only calling an allele if a percentage of reads or at least one read, whichever is higher, support the allele, and if a percentage of unique starting points or at least one unique starting point, whichever is higher, support the genotype.

4. The method of claim 3, wherein the percentage of reads is at least 2.2% and the percentage of starting points is at least 4%.

5. The method of claim 3, wherein an allele is only called if there are at least a certain number of reads per allele and at least a certain number of unique starting points per allele.

6. The method of claim 5, wherein the certain number of reads is at least 4 and the certain number of starting points is at least 8.

7. The method of claim 1, further comprising:
annotating low quality genotypes; and
classifying a degree of low quality into a plurality of categories of increasingly poor quality.

8. The method of claim 1, comprising comparatively analyzing at least two BAM files of interest.

9. The method of claim 8, wherein said comparative analysis comprises the use of Fisher's exact test.

10. The method of claim 9, wherein said comparative analysis comprises the use of Fisher's exact test for a plurality of filter levels.

11. The method of claim 1, wherein PCR based targeted enrichment of said sequence of interest is used prior to sequencing.

12. The method of claim 1, further comprising annotating the single consensus file with further information.

13. The method of claim 9, wherein said further information comprises a dbSNP name or a gene name.

14. The method of claim 1, wherein said method is used for at least one of facilitating mitochondrial quality control and population genetic analyses.

15. The method of claim 1, further comprising flagging non-reference genotypes as potential mismatches.

16. The method of claim 1, further comprising:
detecting hypervariable genomic regions by way of the plurality of sequence read filtering, and by way of flagging the genotypes in the detected hypervariable regions.

17. The method of claim 1, further comprising:
detecting genomic segmental duplications by way of the plurality of sequence read filtering, and by way of flagging the genotypes in the regions as being in a homologous region.

18. A computer-program product, loadable or loaded into a memory of a computer, comprising commands, the commands being readable by the computer to perform the method of claim 1 when the commands are executed on the computer.

19. A computer-readable medium including program code of a computer program for, when executed on a computer, performing the method of claim 1.
